(19) United States
(12) Patent Application Publication
(10) Pub. No.: US 2021/0176575 A1
(43) Pub. Date: Jun. 10, 2021

(54) INFORMATION PROCESSING DEVICE, MUSIC PLAYING SPEED DECISION SYSTEM, AND PROGRAM

(71) Applicant: TOSHIBA TEC KABUSHIKI KAISHA, Tokyo (JP)

(72) Inventors: Takuji Sakaguchi, Nerima Tokyo (JP); Hodaka Mino, Nerima Tokyo (JP)

(21) Appl. No.: 16/926,853

(22) Filed: Jul. 13, 2020

(30) Foreign Application Priority Data
Dec. 9, 2019 (JP) 2019-222444

(51) Int. Cl. H04R 27/00; G06K 9/00; G06F 16/635; G06F 16/683

(52) U.S. Cl. CPC H04R 27/00; G06K 9/00778; H04R 2227/003; G06F 16/683; G06F 16/635

(57) ABSTRACT

An object of an embodiment is to provide an information processing device, a music playing speed decision system, and a program that enable a store to effectively utilize a piece of music played in the store, such as BGM. According to one embodiment, the information processing device includes: a crowd information acquisition unit configured to acquire crowd information representing a crowd level in a store; a decision unit configured to decide a speed of a piece of music played in the store, based on the crowd information acquired by the crowd information acquisition unit; and an output unit configured to output information about the piece of music played at the speed decided by the decision unit.

### CROSS-REFERENCE TO RELATED APPLICATION

This application is based upon and claims the benefit of priority from Japanese Patent Application No.2019-222444, filed on Dec. 9, 2019, the entire contents of which are incorporated herein by reference.

### FIELD

Embodiment described herein relate generally to an information processing device, a music playing speed decision system, and a program.

### BACKGROUND

According to the related art, mass retailer stores employ the practice of playing music such as so-called BGM (background music). To play BGM in the stores, a BGM distribution system for selecting a piece of music according to the state in the store is proposed.

The BGM distribution system according to the related art selects a piece of BGM, based on information about customers inputted to a POS (point of sales) terminal. Specifically, the BGM distribution system acquires customer information such as gender and age, then determines the customer base in the store based on the customer information, and selects BGM that is expected to be liked by this customer base.

The BGM distribution system is intended exclusively to provide apiece of music that customers will find comfortable, and is not aimed at prompting any change in customers' purchase behavior. Preferably, the store may effectively utilize BGM or the like played in the store, for example, to alleviate overcrowding in the store.

### DESCRIPTION OF THE DRAWINGS

FIG. 1 shows an entire system including an information processing device of an embodiment.

FIG. 2 shows an outline of a store employing a music playing speed decision system.

FIG. 3 is a block diagram showing the hardware configuration of the information processing device.

FIG. 4 shows contents of a music list section.

FIG. 5 shows contents of an attribute table.

FIG. 6 is a block diagram showing the functional configuration of the information processing device.

FIG. 7 is a sequence chart showing a flow employed by the entire system.

FIG. 8 is a flowchart showing processing by a control unit.

### DETAILED DESCRIPTION

An object of an embodiment is to provide an information processing device, a music playing speed decision system, and a program that enable a store to effectively utilize a piece of music played in the store, such as BGM.

In general, according to one embodiment, an information processing device includes: a crowd information acquisition unit configured to acquire crowd information representing a crowd level in a store; a decision unit configured to decide a speed of a piece of music played in the store, based on the crowd information acquired by the crowd information acquisition unit; and an output unit configured to output information about the piece of music played at the speed selected by the decision unit.

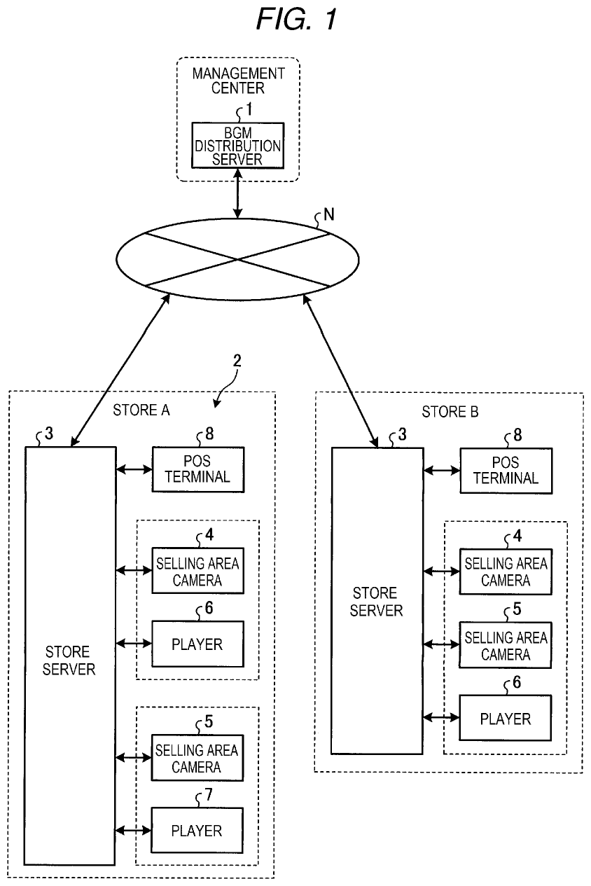

An embodiment of an information processing device and a music playing speed decision system will now be described. FIG. 1 shows a BGM distribution system including an information processing device and a music playing speed decision system. The BGM distribution system has a BGM distribution server 1 and a music playing speed decision system 2.

The BGM distribution server 1 is provided at a management center of a corporation providing a BGM distribution service to a mass retailer or the like. The BGM distribution server 1 stores many BGM contents. The music playing speed decision system 2 is installed at each store of a corporation operating a mass retailer. The music playing speed decision system 2 has a store server 3 and ceiling area cameras 4, 5.

The store server 3 forms an information processing device and is connected to the BGM distribution server 1 via a network N such as the internet. The store server 3 is also connected to the ceiling area cameras 4, 5, players 6, 7, and a POS terminal 8 via a network such as a LAN (local area network). The ceiling area cameras 4, 5 form a detection device detecting the crowd level in the store and pick up an image showing the state of the selling area in the store. The ceiling area cameras 4, 5 also have the function of a detection device detecting a change in the crowd level in the store, and the function of a recognition device recognizing an attribute of a customer in the store. The “crowd level in the store” may be the number of customers in the entire area of the store or may be the number of customer in a predetermined area such as a first area Y or a second area Z, described later. That is, the “crowd level in the store” may be what is defined based on the number of customers present in any area, for example, the number of customers, or the number of customers per unit area or the like.

The players 6, 7 play a BGM content distributed from the BGM distribution server 1. In a store A in FIG. 1, the ceiling area is divided into sections, and a BGM content based on the result of image pickup by the ceiling area cameras 4, 5 is provided on a per section basis. Meanwhile, in a store B, the ceiling area cameras 4, 5 are installed on a per section basis of the selling area. One player 6 is provided and the same BGM content is provided to the entire selling area. The number of players can be suitably set according to the size of the selling area. The POS terminal 8 is arranged in the selling area and performs commodity registration processing and payment processing.

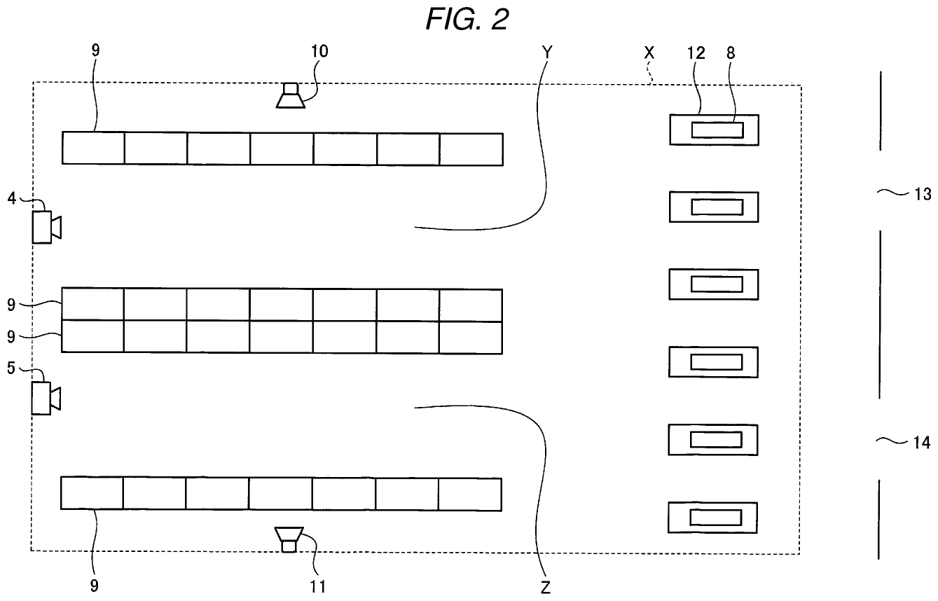

FIG. 2 shows an example of an outline of the store A employing the BGM distribution system. In a selling area X of a mass retailer such as a supermarket, many product display shelves 9 are arranged. The selling area X is divided into a first area Y and a second area Z by the product display shelves 9. In the first area Y, the selling area camera 4 picking up an image showing the state of customers present in the first area Y, and a speaker 10 connected to the player 6 for playing BGM in the first area Y, are provided. Similarly, in the second area Z, the selling area camera 5 picking up an image showing the state of customers present in the second area Z, and a speaker 11 connected to the player 7 for playing BGM in the second area Z, are provided.

In the selling area X, a plurality of checkout counters 12 where the customer performs the accounting, are installed. The POS terminal 8 is provided on each checkout counter 12. In the illustration, the reference number 13 is the entrance of the selling area X and the reference number 14 is the exit. Instead of the selling area cameras 4, 5, a detection device that can recognize the passage of a person, such as a camera or infrared sensor, can be provided at each of the entrance 13 and the exit 14. Thus, the crowd level in the selling area X can be detected, based on the number of people entering the selling area X and the number of people exiting the selling area X.

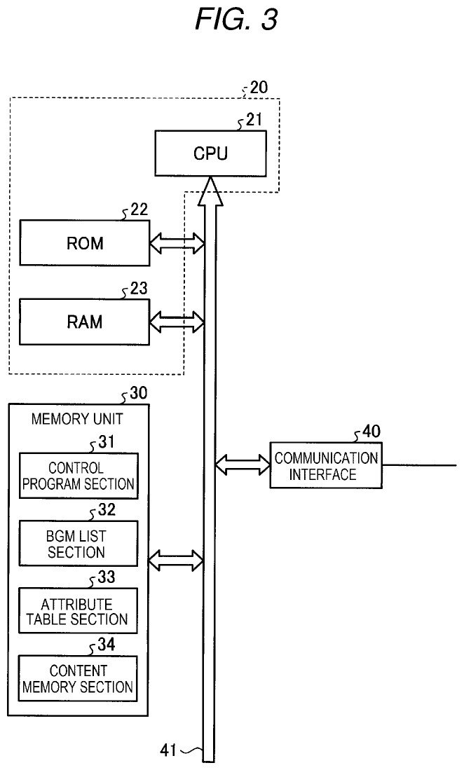

The hardware configuration of the store server 3 will now be described with reference to FIG. 3. The store server 3 is formed of a computer and has a control unit 20, a memory unit 30, a communication interface 40, and the like. The control unit 20, the memory unit 30, and the communication interface 40 are connected to each other via a bus 41.

The control unit 20 has a CPU (central processing unit) 21, a ROM (read-only memory) 22, and a RAM (random-access memory) 23. The CPU 21, the ROM 22, and the RAM 23 are connected to each other via the bus 41. The CPU 21 controls the operations of the store server 3 as a whole. The ROM 22 stores various programs such as a program used to drive the CPU 21, and various data. The RAM 23 is used as a work area for the CPU 21. In the RAM 23, various programs and various data stored in the ROM 22 and the memory unit 30 are loaded. As the CPU 21 operates according to a control program stored in the ROM 22 or the memory unit 30 and loaded in the RAM 23, the control unit 20 executes various kinds of control processing in the store server 3.

The memory unit 30 has a control program section 31, a BGM list section 32, an attribute table section 33, and a content memory section 34. The control program section 31 stores various control programs, in addition to a control program for the store server 3 to function as an information processing device that is a part of the music playing speed decision system 2.

The control program may be provided in the form of being recorded in a computer-readable recording medium such as a CD-ROM. Also, the control program executed by the information processing device in this embodiment may be provided in the form of being stored on a computer connected to a network such as the internet and then downloaded via the network. Moreover, the control program may be provided or distributed via a network such as the internet.

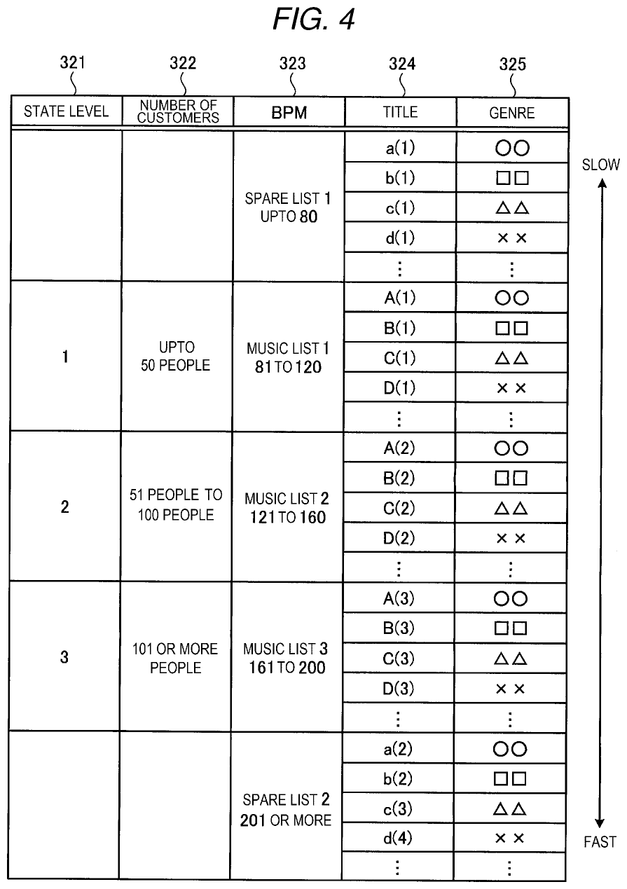

The BGM list section 32 stores a list of pieces of BGM to be played by the players 6, 7. Specifically, as shown in FIG. 4, the BGM list is a list of pieces of music corresponding to store state level 321, number of customers 322, BPM (beats per minute) 323, title 324, and genre 325. The state level 321 indicates the degree of crowd in the selling area and is set on a per number of customers recognized by each selling area camera. The number of customers 322 is the number of customers recognized by each selling area camera. The BPM 323 is broadly known value indicating the speed of a piece of music and defines a range of BPM values corresponding to the state level 321. The title 324 is the title of BGM. The genre 325 is the genre of music of the BGM content, such as classical, pop, rock, and traditional-style Japanese popular ballad.

The BGM list is set in such a way that the speed of music becomes higher as the number of customers becomes larger. This is based on the result of research showing that the walking speed of customers becomes higher as the tempo (speed) of BGM becomes higher in a supermarket or the like. Specifically, when the degree of crowd is high, playing a piece of music at a high speed facilitates the movement of customers and thus alleviates overcrowding. Meanwhile, when the degree of crowd is low, playing a piece of music at a low speed restrains the movement of customers and causes the customers to stay longer, and thus leads to increased sales.

The BGM list is used to decide the music speed of BGM played in the selling area. As will be described in detail later, as an example of the decision, if the number of customers picked up by the selling area camera 4 is fewer than 50 people, the control unit 20 determines that the state level is 1 and decides to play a piece of music in a music list 1 with BPM values of 81 to 120. Also, the way in which pieces of music in spare lists 1, 2 corresponding to the state level 321 and the number of customers 322 that are blank in FIG. 4 will be described later.

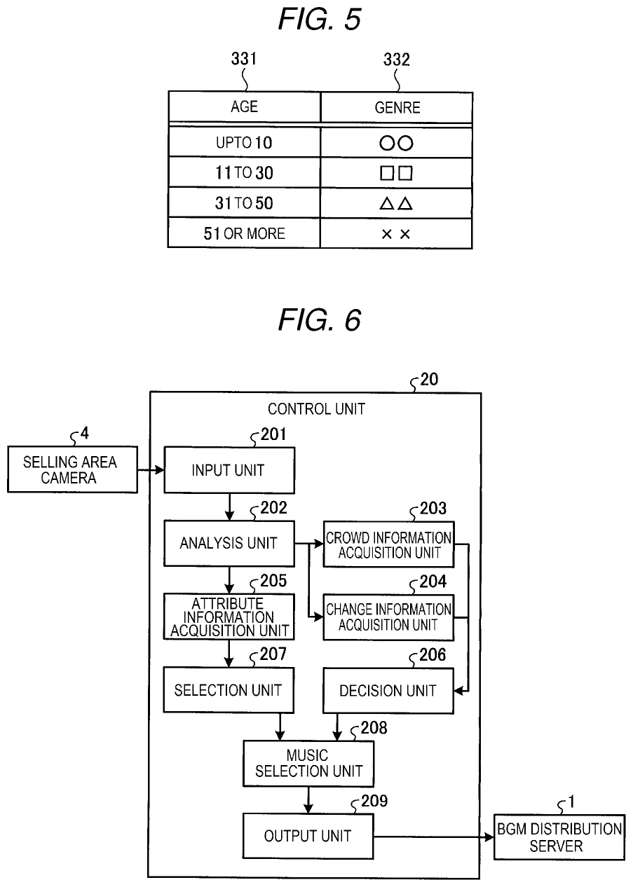

The attribute table section 33 in the memory unit 30 stores an attribute table showing a correspondence between age 331 and music genre 332, which is an example of attribute of customers, as shown in FIG. 5. As an attribute, not only age but also anything that can be estimated at least via the selling area camera 4, such as gender, can be used. The content memory section 34 stores a BGM content distributed from the BGM distribution server 1.

The communication interface 40 is connected to the BGM distribution server 1, the selling area cameras 4, 5, the players 6, 7, and the POS terminal 8. Thus, the control unit 20 can transmit and receive information (data) to and from each of the BGM distribution server 1, the selling area cameras 4, 5, the players 6, 7, and the POS terminal 8.

The functional configuration of the control unit in the store server 3 will now be described with reference to FIG. 6. As the CPU 21 operates according to the control program stored in the ROM 22 or the control program section 31 in the memory unit 30, the control unit 20 functions as an input unit 201, an analysis unit 202, a crowd information acquisition unit 203, a change information acquisition unit 204, an attribute information acquisition unit 205, a decision unit 206, a selection unit 207, a music selection unit 208, and an output unit 209.

The input unit 201 inputs crowd information outputted from an information output unit of the detection device detecting the crowd level in the store. Specifically, the input unit 201 input image information of the first area Y of the selling area from an information output unit of the selling area camera 4. This image information is a kind of crowd information. The analysis unit 202 analyzes the image information inputted by the input unit 201 and grasps the number of customers present in the first area Y and the estimated ages of the customers. In addition, the analysis unit 202 generates estimated age distribution of the customers present in the first area Y. The analysis unit 202 also compares the image information inputted by the input unit 201 with previously inputted image information and calculates a change in the number of customers present in the first area Y.

The crowd information acquisition unit 203 acquires crowd information representing the crowd level in the store. Specifically, the crowd information acquisition unit 203 acquires the number of customers which is the result of the analysis by the analysis unit 202. The change information acquisition unit 204 acquires change information representing a change in the crowd level in the store. Specifically, the change information acquisition unit 204 acquires the change in the number of customers which is the result of the analysis by the analysis unit 202. The attribute information acquisition unit 205 acquires attribute information of customers present in the store. Specifically, the attribute information acquisition unit 205 acquires the estimated age distribution of the customers generated by the analysis unit 202.

The decision unit 206 decides the speed of music played in the store, based on the crowd information acquired by the crowd information acquisition unit 203. In this embodiment, the decision unit 206 decides the speed of the piece of BGM played in the first area Y, based on the crowd information from the crowd information acquisition unit 203 and the change information from the change information acquisition unit 204.

The selection unit 207 selects the genre of the piece of music played in the store, based on the attribute information acquired by the attribute information acquisition unit 205. In this embodiment, the selection unit 207 selects the genre corresponding to the largest age group of customers present in the store, based on the estimated age distribution of the customers from the attribute information acquisition unit 205 and with reference to the attribute table shown in FIG. 5.

The music selection unit 208 selects pieces of music that satisfy the condition from among the music lists shown in FIG. 4 and generates a music list, based on the speed of music decided by the decision unit 206 and the genre selected by the selection unit 207. The output unit 209 outputs information about pieces of music corresponding to the speed decided by the decision unit 206. In this embodiment, the output unit 209 transmits the music list generated by the music selection unit 208 to the BGM distribution server 1. The output unit 209 outputs the music list and thus outputs information about the pieces of music corresponding to the speed and information about the genre of the pieces of music.

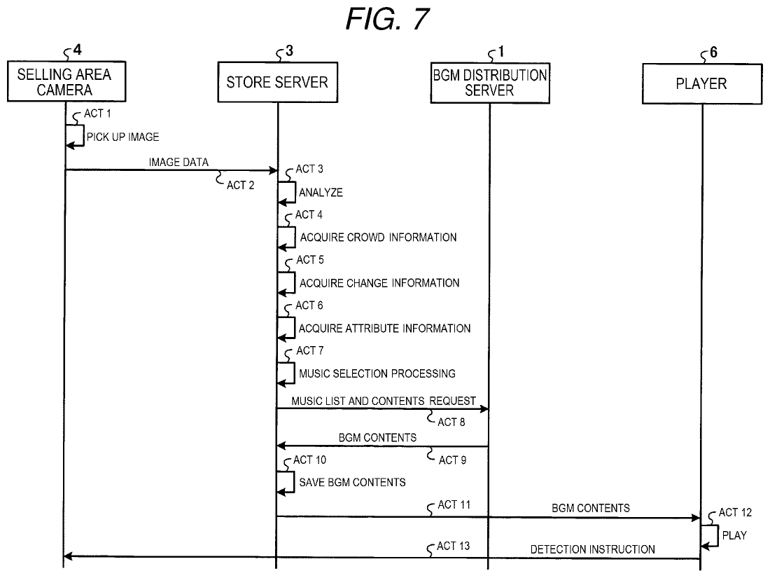

The operations of the BGM distribution system including the music playing speed decision system 2 according to this embodiment will now be described with reference to FIG. 7. The sequence chart shown in FIG. 7 shows an example of picking up an image of the first area Y by the selling area camera 4 and setting a piece of BGM to be played in the first area Y by the player 6 and the speaker 10. To set a piece of BGM to be played in the second area Z, the BGM distribution system carries out a similar operation, using the selling area camera 5, the player 7, and the speaker 11. In the case of the store B shown in FIG. 1, the BGM distribution system sets a piece of BGM, based on information from the selling area camera that detects a larger number of customers, of the selling area cameras 4, 5.

First, the selling area camera 4 picks up an image of the first area Y (ACT 1) and transmits the picked-up image data to the store server 3 (ACT 2). The image data is a kind of crowd information representing the crowd level in the store. The analysis unit 202 of the store server 3 analyzes the received image data (ACT 3). Based on the result of the analysis, the crowd information acquisition unit 203 acquires the crowd information, that is, the number of customers present in the first area Y (ACT 4). Similarly, based on the result of the analysis by the analysis unit 202, the change information acquisition unit 204 acquires change information, that is, the difference between the number of customers based on the result of the analysis on image data previously received from the selling area camera 4 and the number of customers based on the result of the analysis on the image data that is received this time (ACT 5). Also, based on the result of the analysis by the analysis unit 202, the attribute information acquisition unit 205 acquires the attribute information, that is, the age distribution of the customers present in the first area Y (ACT 6).

The store server 3 then performs music selection processing (ACT 7). The music selection processing is the processing of generating a music list to be outputted from the output unit 209, based on the speed of music decided by the decision unit 206 and the genre of music selected by the selection unit 207. Details of the music selection processing will be described later, using a flowchart.

When the music list is generated, the output unit 209 of the store server 3 outputs a BGM content distribution request along with the music list to the BGM distribution server 1 (ACT 8). In response to the BGM content distribution request from the store server 3, the BGM distribution server 1 transmits BGM contents of the pieces of music in the music list to the store server 3 (ACT 9).

The store server 3 temporarily stores the received BGM contents into the content memory section 34 (ACT 10) and transmits a piece of music to the player 6 when the timing to play the piece of music in the first area Y comes (ACT 11). The player 6 plays back the received piece of music and thus plays the piece of music via the speaker 10 provided in the first area Y (ACT 12). The player 6 outputs a detection instruction to the selling area camera 4 a predetermined time prior to the end of the piece of music currently being played, for example, one minute prior to the end of the piece of music (ACT 13). In response to the detection instruction, the selling area camera 4 picks up an image showing the state of the first area Y at the time (ACT 1). Then, the above processing is repeated. In this embodiment, the selling area camera 4 picks up image data at the time during the playback of a piece of music and transmits the picked-up image data to the store server 3. However, the selling area camera 4 may transmit image data to the store server 3 every predetermined time, for example, every 15 minutes.

Through the above flow, a piece of music to be played in the first area Y is set. In other words, the speed of the piece of music played in the first area Y is decided, based on the crowd level in the first area Y, and the genre of music is decided, based on an attribute of customers in the first area Y.

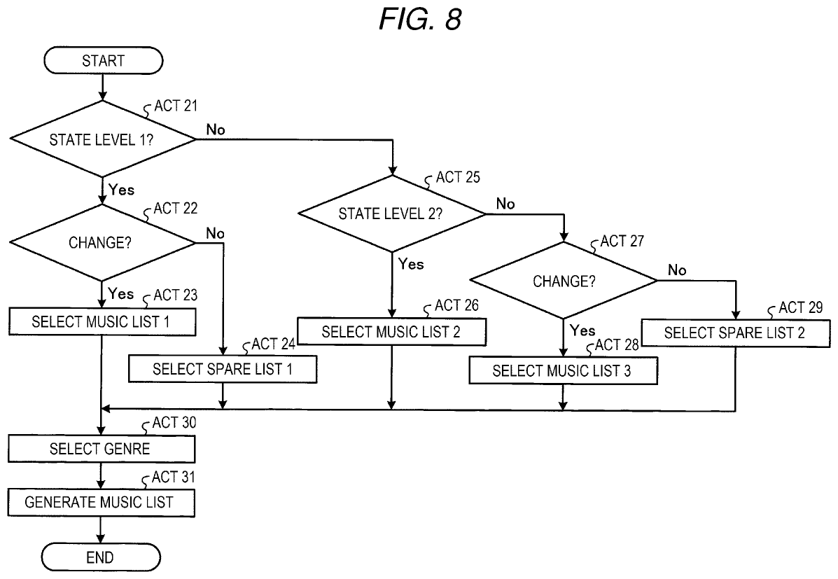

The music selection processing carried out by the control unit 20 will now be described with reference to the flowchart of FIG. 8. The decision unit 206 determines whether the state level is 1 or not, based on the crowd information acquired by the crowd information acquisition unit 203 (ACT 21). Specifically, the decision unit 206 determines whether the number of customers in the first area Y is 50 people or fewer, or not. If the state level is 1 (Yes in ACT 21), the decision unit 206 determines whether there is any change or not, based on the change information acquired by the change information acquisition unit 204 (ACT 22). Specifically, the decision unit 206 determines whether the number of customers in the first area Y acquired by the crowd information acquisition unit 203 is increased by 5 people or more from the previous number of customers, or not.

If there is a change (Yes in ACT 22), the decision unit 206 selects the music list 1 (ACT 23). If there is no change (No in ACT 22), the decision unit 206 selects the spare list 1 (ACT 24). If the number of customers is increased by 5 people or more at the state level 1, where the degree of crowd is low, the piece of music in the music list 1 played at the time is determined as effective (increasing the staying time) and therefore the speed of the music list 1 is maintained. If the piece of music is determined as effective, the speed of the music list 1 is maintained so as not to make customers feel uncomfortable due to unnecessary slowdown of the music. If the number of customers is not increased by 5 people or more, the music list 1 is determined as not effective and therefore the spare list 1 with faster pieces of music is selected.

If the state level is not 1 in ACT 21 (No in ACT 21), the decision unit 206 determines whether the state level is 2 or not (ACT 25). If the state level is 2 (Yes in ACT 25), the decision unit 206 selects the music list 2 (ACT 26). Specifically, the decision unit 206 determines whether the number of customers in the first area Y is 51 people or more and 100 people or less, or not. If the state level is 2, the decision unit 206 determines the number of customers in the first area Y as appropriate and selects the music list 2, which does not actively prompt customers to take any particular action.

If the state level is not 2 in ACT 25 (No in ACT 25), that is, if the state level is 3, where the number of customers is 101 people or more, the decision unit 206 determines whether there is any change or not, based on the change information acquired by the change information acquisition unit 204 (ACT 27). This determination on whether there is a change or not is the determination on whether the number of customers in the first area Y acquired by the crowd information acquisition unit 203 is decreased by 5 people or more from the previous number of customers, or not.

If there is a change (Yes in ACT 27), the decision unit 206 selects the music list 3 (ACT 28). If there is no change (No in ACT 27), the decision unit 206 selects the spare list 2 (ACT 29). If the number of customers is decreased by 5 people or more at the state level 3, where the degree of crowd is high, the piece of music in the music list 3 played at the time is determined as effective (alleviating overcrowding) and therefore the speed of the music list 3 is maintained. If the piece of music is determined as effective, the speed of the music list 3 is maintained so as not to make customers feel uncomfortable due to unnecessary speedup of the music. If the number of customers is not decreased by 5 people or more, the music list 3 is determined as not effective and therefore the spare list 2 with even faster pieces of music is selected.

After the decision unit 206 selects one of the music lists and decides the speed of music, the selection unit 207 selects a genre based on the attribute information acquired by the attribute information acquisition unit 205 (ACT 30). Specifically, the selection unit 207 selects the genre corresponding to the largest age group of customers in the first area Y, referring to the attribute table in FIG. 5. Subsequently, the music selection unit 208 extracts pieces of music corresponding to the genre selected by the selection unit 207, from the music list corresponding to the music speed decided by the decision unit 206, and generates a music list (ACT 31). Then, the music selection processing ends.

As described above, the store server 3, which is the information processing device in this embodiment, decides the speed of music played in the store according to the crowd level in the store and outputs information about pieces of music corresponding to this speed. Specifically, the speed of music becomes higher as the degree of crowd in the store becomes higher. Therefore, the BGM distribution system receiving the output from the store server 3 provides, to the store, a piece of music with a higher speed corresponding to a higher degree of crowd and thus can prompt the movement of customers and can lead to alleviation of overcrowding in the store. Meanwhile, if the degree of crowd is low, the BGM distribution system provides, to the store, a piece of music with a lower speed and thus can restrain the movement of customers and increase the staying time, leading to an increase in sales in the store. Thus, the store server 3 in this embodiment enables a store to effectively utilize music played in the store, such as BGM.

As shown in FIG. 4, the number of customers indicating the degree of crowd and the BPM value indicating the speed are both defined over a certain range. As is clear from this definition, the condition that the speed of music becomes higher as the degree of crowd becomes higher as referred to in this description does not require a one-to-one relationship between the degree of crowd (number of customers) and the speed of music (BPM value).

The store server 3 in this embodiment acquires crowd information representing the crowd level at the time when a piece of music is played in the store, and decides the speed of the next piece of music to be played. Therefore, the speed of music played in the store can be decided in good timing corresponding to the state in the store, and the purchase behavior of customers can be changed swiftly.

Also, the store server 3 in this embodiment decides the speed of music in consideration of the change information in addition to the crowd level. Therefore, whether the music played based on the crowd level causes a change in the purchase behavior of customers or not can be checked. If the music is considered not very effective, the speed of music can be changed further to lead to improve effectiveness. Moreover, the store server 3 in this embodiment selects a genre of music according to the attribute information and therefore can play music that is considered to meet the preference of customers.

Although the store server 3 in this embodiment outputs a music list to the BGM distribution serve 1 and thus outputs information about pieces of music corresponding to the speed, the store server 3 may output only the BPM value indicating the speed of music. Similarly, while the store server 3 in this embodiment outputs a music list to the BGM distribution server 1 and thus outputs information about the genre of music, the store server 3 may output only the genre. In these cases, the BGM distribution server 1 selects a piece of music according to the received BPM value and genre. If the BGM distribution server 1 receives only the BPM value, the BGM distribution server 1 may change only the speed of the currently played piece of music, instead of changing to a piece of music with a different speed. If the control unit 20 of the store server 3 determines that the degree of crowd is higher in the first area Y than in the second area Z as a result of comparing the crowd levels in the first area Y and the second area Z, the store server 3 may output information about a piece of music having a speed corresponding to the degree of crowd in the first area Y, to the BGM distribution server 1. Consequently, the speed of music played in each area can be set, based on the area where the degree of crowd is higher.

While BGM distribution server 1 has BGM contents in this embodiment, the store server 3 may have BGM contents. Also, while the BGM distribution system is applied to a selling area in this embodiment, the BGM distribution system can be applied to various places in a store including indoor and outdoor sites. Although the relationship between the degree of crowd and the speed of music in this embodiment is set as shown in FIG. 4, the setup can be suitably changed, such as raising or lowering the state level or changing the BPM value corresponding to each state level.

The embodiment is presented as an example and is not intended to limit the scope of the disclosure. The embodiment can be carried out in various other forms. Various omission, replacements, and alterations can be made without departing from the scope of the disclosure. The embodiment and modifications thereof are included in the scope and the gist of the disclosure and also included in the scope of what is described in the claims and equivalents thereof.

What is claimed is:

1. An information processing device, comprising:
a crowd information acquisition component configured to acquire crowd information representing a crowd level in a store;
a decision component configured to decide a speed of piece of music played in the store, based on the crowd information acquired by the crowd information acquisition component; and
an output component configured to output information about the piece of music played at the speed decided by the decision component.

2. The information processing device according to claim 1, wherein
the decision component decides to employ a higher speed as a degree of crowding based on the crowd information acquired by the crowd information acquisition component becomes higher.

3. The information processing device according to claim 1, wherein
the crowd information acquisition component acquires crowd information representing the crowd level at the time when a piece of music is played in the store, and
the decision component decides the speed of next piece of music to be played after the piece of music played when the crowd information acquisition component acquires the crowd information.

4. The information processing device according to claim 1, further comprising
a change information acquisition component configured to acquire change information representing a change in the crowd level in the store, wherein
the decision component decides the speed of the piece of music played in the stored, based on the crowd information and the change information.

5. The information processing device according to claim 1, further comprising:
an attribute information acquisition component configured to acquire attribute information representing an attribute of a customer present in the store; and
a selection component configured to select a genre of the piece of music played in the store, based on the attribute information acquired by the attribute information acquisition component, wherein
the output component outputs information about the genre selected by the selection component, along with the information about the piece of music played at the speed.

6. A music playing speed decision system comprising a detection device configured to detect a crowd level in a store and an information processing device connected to the detection device via a network,
the detection device comprising:
an information output component configured to output crowd information representing the crowd level in the store,
the information processing device comprising:
a crowd information acquisition component configured to acquire the crowd information outputted from the information output component;
a decision component configured to decide a speed of a piece of music played in the store, based on the crowd information acquired by the crowd information acquisition component; and
an output component configured to output information about the piece of music played at the speed selected by the decision component.

7. The music playing speed decision system according to claim 6, wherein
the decision component decides to employ a higher speed as a degree of crowding based on the crowd information acquired by the crowd information acquisition component becomes higher.

8. The music playing speed decision system according to claim 6, wherein
the crowd information acquisition component acquires crowd information representing the crowd level at the time when a piece of music is played in the store, and
the decision component decides the speed of next piece of music to be played after the piece of music played when the crowd information acquisition component acquires the crowd information.

9. The music playing speed decision system according to claim 6, further comprising
a change information acquisition component configured to acquire change information representing a change in the crowd level in the store, wherein
the decision component decides the speed of the piece of music played in the stored, based on the crowd information and the change information.

10. The music playing speed decision system according to claim 6, further comprising:
an attribute information acquisition component configured to acquire attribute information representing an attribute of a customer present in the store; and
a selection component configured to select a genre of the piece of music played in the store, based on the attribute information acquired by the attribute information acquisition component, wherein
the output component outputs information about the genre selected by the selection component, along with the information about the piece of music played at the speed.

11. The music playing speed decision system according to claim 6, wherein
the detection device comprises a plurality of ceiling cameras.

12. A non-transitory computer readable storage medium comprising a program for controlling an information processing device, the program causing a computer to perform functions comprising:
acquiring crowd information representing a crowd level in a store;
deciding a speed of a piece of music played in the store, based on the crowd information acquired; and
outputting information about the piece of music played at the speed selected by deciding the speed of the piece of music played in the store.

13. The non-transitory computer readable storage medium according to claim 12, the functions further comprising:
deciding to employ a higher speed as a degree of crowding based on the crowd information acquired becomes higher.

14. The non-transitory computer readable storage medium according to claim 12, the functions further comprising:
acquiring crowd information representing the crowd level at the time when a piece of music is played in the store; and
deciding the speed of next piece of music to be played after the piece of music played when acquiring the crowd information.

15. The non-transitory computer readable storage medium according to claim 12, the functions further comprising:
acquiring change information representing a change in the crowd level in the store; and
deciding the speed of the piece of music played in the stored, based on the crowd information and the change information.

16. The non-transitory computer readable storage medium according to claim 12, the functions further comprising:
acquiring attribute information representing an attribute of a customer present in the store;
selecting a genre of the piece of music played in the store, based on the attribute information acquired; and
outputting information about the genre selected along with the information about the piece of music played at the speed.
